(19) United States
(12) Patent Application Publication
(10) Pub. No.: US 2005/0228537 A1
(43) Pub. Date: Oct. 13, 2005

(54) Method and device for selling goods and for handling over the purchased goods

(76) Inventors: Karl-Heinz Unkelbach, Cologne (DE); Hans-Dieter Baumgart, Neuss (DE)

Correspondence Address: STETINA BRUNDA GARRED & BRUCKER, 75 ENTERPRISE, SUITE 250, ALISO VIEJO, CA, 92656, US

(21) Appl. No.: 11/101,197

(22) Filed: Apr. 7, 2005

(30) Foreign Application Priority Data
Apr. 10, 2004 (DE) 10 2004 017 949.2

(51) Int. Cl. A63F 9/02; G06F 17/00

(52) U.S. Cl. 700/237

(57) ABSTRACT

The invention relates to a logistics system and to a method for selling goods, wherein within a display area, goods are presented; an individual PIN is allocated to each customer; goods selected by customers are conveyed to at least one intermediate storage area by way of a transport device; the goods belonging to a particular customer are identified by verifying the PIN and are conveyed to at least one storage area which is reserved for this customer; and after payment and collection from the storage area in the intermediate storage area the goods are handed over to the customer in a goods collection area. Known methods are associated with the disadvantage in that the customer can only select generic goods. The invention avoids this in that at least some of the goods are offered to the customer for sale as concretely singled-out goods, wherein the customer marks these concretely singled-out goods with his or her PIN, hands them over to a transport device, and wherein subsequently the goods are conveyed from the sales space to the storage area by way of at least one transport device.

The invention relates to a method and a device for selling goods and for handing over the purchased goods, wherein shopping trolleys, which are disadvantageous to both customers and traders, as well as the carrying of bags and baskets are replaced by an essentially automatic transport device.

In modern department stores, shopping centres, supermarkets, shopping malls and similar, hereinafter referred to as markets, it is common for a customer who enters the market to take a shopping trolley in the entrance area and to push this trolley along while shopping. The customer removes the selected goods from the shelf on which they are presented, places them in the shopping trolley and pushes this shopping trolley to the next shelf where s/he wishes to buy other goods. This continues until s/he reaches a cash register with the full shopping trolley and places the goods onto a belt conveyor. There, a checkout cashier determines the price of the goods, an invoice is prepared and the customer pays. Then the customer places the goods in the trolley again and pushes it to his or her motor vehicle where everything is repacked once more. As an alternative, s/he fills one or several bags which s/he carries home or to a place where the goods are stored.

This method has significant disadvantages both to the customer and to the trader:
The necessity for, and the purchase of, a shopping trolley: the customer requires a shopping trolley which s/he has to obtain when entering the market and leave at the end. The shopping trolley, together with many other shopping trolleys, is stored in rows near the entrance. During busy periods customers have to wait their turn to obtain a shopping trolley, which frequently results in disagreeable jostling, and possibly even arguments. A coin is needed to release the shopping trolley. Depending on the quantity of goods the customer requires, more than one shopping trolley may be needed, which makes shopping more difficult.
The customer must push the shopping trolley along for the duration of shopping and must keep an eye on it because it contains his/her coin.
Inside the market, the shopping trolley, together with the shopping trolleys of all the other customers, constantly cause crowding and jostling. At times, due to shopping trolleys of other customers being in the way, the customer cannot get close to the shelves in order to make his/her selection at leisure. Shopping trolleys are pushed along or even mistaken for those of others, so that the purchases of several customers may be mixed up. This reduces the pleasure of shopping.
As the shopping trolley fills up with goods it becomes hard to push along and hard to manoeuvre. Because of the large number of shopping trolleys the aisles between the shelves have to be straight and wide, which makes the market look impersonal and unattractive. Furthermore, when compared to a setup involving narrower aisles, considerably fewer goods can be presented, and the interior architecture of the market cannot take account of the specific requirements of the products on offer.
At the cash register, the customer usually has to wait in a queue because, for each customer, the checkout cashier has to transfer the price for each item to a cash register before the invoice is prepared. Payment and repacking, too, require an annoying amount of time, and due to the shopping trolleys the queues are very long, which again requires considerable space.
Purchasing shopping trolleys represents a significant investment to the proprietor of the market. Maintenance expenditure for shopping trolleys is also very considerable. Time and again, shopping trolleys are stolen or demolished, and constant use results in damage. Year after year between 10% and 25% of shopping trolleys have to be purchased anew.
In department stores with many individual sections, or in shopping centres with individual businesses, in each section the customer receives the goods purchased in that section in a plastic bag, so that before long s/he has to walk through the various sections or through the shopping centre, loaded with many heavy and bulky bags.

A method is generally known in which, for example in textile stores, the customer selects an item of clothing and hands it over to a sales assistant who takes it to a goods collection area near the cash register. The customer can collect the garment from the goods collection area having previously paid for it at the cash register. However, this method is very labour-intensive and cost-intensive and is practicable only in the case of high-value goods of large dimensions and with little quantitative goods turnover.

Furthermore, from WO 02/17164 A2 a method is known in which the customer selects goods in a demonstration space, enters a product code at a cash register, pays, and then from a large warehouse obtains an item of the goods type selected. First of all, from a legal point of view this is a generic purchase, wherein the purchased product is concretely singled out only in the warehouse by the act of issuing the product. This method is for example practiced in self-service furniture stores, and is usually only practicable in the case of large items and goods where the individual products of the type cannot be differentiated from each other. On the other hand, in such a system it is not possible for the customer to single out specific goods, as is usually desired when purchasing vegetables or meat.

Finally, businesses comprising vending machines are known from the sixties of the 20^{th} century, in which customers remove one item of the goods from a compartment, having previously put some money into a slot. In this system the customer cannot select between various items of the same type of goods, or very large vending machines are required to make it possible to remove a multiple number of products of one type while paying all at once. Moreover, the customer can only inspect the goods to a limited extent. These vending machines therefore found little acceptance and have disappeared from the market.

Furthermore, methods are known in which goods are selected, on the internet or in catalogues, with the use of a personal identification number (PIN), with the goods, after the customer has paid for them, then being removed from a store and sent to the customer. There are product ranges which cannot, or cannot easily, be sold by way of the internet or catalogues. This is partly because customers, when they are shopping, often want to search through a large number of goods and then select an item which they can touch and inspect. A customer then wants to acquire precisely this item and not a similar item or an identical one. However, the above-mentioned methods are precisely unable to provide this service.

It is thus the object of the invention to create a goods logistics system in conjunction with the sale of goods, which system avoids the disadvantages, described above, of selling goods involving the use of shopping trolleys and shopping bags. In particular it is a further object of the invention to also facilitate the sale of low-volume low-priced goods involving a high turnover of items.

This object is met by the method according to claim 1 and the device according to claim 16. Expediently, the respective claims describe embodiments of, and improvements to, the method or device.

The following definitions are used in this document:
Shelf refers to any functional part for displaying or offering goods, in particular including a shelf, freezer, counter, bargain counter and similar for presenting goods for self-service or conventional service.
PIN refers to a sequence of characters which is characteristic to each customer, at least during the purchase.
Transport aid refers to any device which simplifies the transport of a particular item or which for example prevents or delays thawing of the item. This includes in particular pallets, open and closed containers and stands or insulating containers. The PIN can be applied to the transport aid or it can be stored in a chip of the transport aid.
Terminal refers to any input and/or output device for information. It can contain keypads, scanners, cameras and displays, touchscreens, sensors for electronically marking labels, and scales, depending on the function which it has to serve in a given position. Furthermore the terminal can contain a decentralised computer system with software in order to process data for a central computer.

The method according to the invention consists of
the goods within a display area in the market being presented on shelves;
a customer-specific character sequence (PIN) being generated after initiation by the customer;
in each case, the goods selected by the customers being marked using this PIN;
the goods marked in this way being conveyed by way of at least one transport device to at least one storage area of an intermediate storage area, which former storage area is reserved for the customer;
upon request by the customer, the goods to be purchased by him/her being brought together from the respective storage areas of the intermediate storage area and, after payment by the customer, being handed over to the customer at a goods release area.

For better explanation the method will be described below with reference to one example. The customer enters the market without having to bother about a shopping trolley or shopping basket and has a look at the goods presented.

After the customer has decided on a particular item, first a character sequence (PIN) is generated which can unambiguously be allocated to this particular customer. This can happen in one of various ways:
1. The customer activates a key, intended for this purpose, of a terminal placed nearby, and receives a PIN which s/he remembers.
2. The customer enters a character sequence of his/her choice and receives confirmation, or a change suggestion if this PIN has already been allocated.
3. The customer enters an image of a person or an object (e.g. passport photo or item of jewellery) by way of a corresponding input device (scanner) at the terminal, with the system then converting this image to an internal PIN.
4. The customer enters a biometric sign (finger print or iris image) in a respective input device (scanner) on the terminal, with the system then converting this image to an internal PIN.
5. As an alternative an analogous process is undertaken, corresponding to the state of the art at the time.

With each further purchase, the customer enters his/her PIN or places his/her image or biometric sign against the scanner, which automatically produces the PIN. Applying the PIN (marking) onto the item to be purchased takes place
1. by affixing a label;
2. by electronically supplementing the information which the selected item contains in an electronic chip (for example an RFID); or
3. by placing the item into a transport aid which contains this information.
4. A different type of affixing, understood in this context, involves electronic tracking of the item in its respective spatial position and the PIN being allocated to the respective position of the item.

Of course any other imaginable method is applicable, provided the customer-specific information can only be connected to the goods with an adequate degree of security. If the goods do not contain any price information, for example by way of a bar code, such price information can also be affixed.

If customers wish to transport and pay for some of the goods separately (for example in the case of groceries, office supplies which attract a tax deduction, or if they wish to have goods for a third party invoiced separately from their own goods) in the way described above they can generate a second PIN, for example in the case of the biometric characteristic by using the fingerprint of the thumb as the first PIN, and the fingerprint of the index finger as a second PIN), and can thus separately store the groups of goods. As an alternative, terminals can also comprise a function for allocating multiple PINs, or for administering sub-PINs.

The item is then conveyed to a transport system which conveys it to an intermediate storage area that can be allocated to the customer, or is even conveyed to the final storage area associated with the goods release area. Depending on the type of system in use, placing the item onto the transport system takes place manually or by means of a lifting system according to the state of the art. Preferably the transport system is designed such that other customers do not have any access to it. This prevents the goods from being removed without authorisation or from being tampered with or damaged when they have disappeared from the customer's field of vision.

Transport can be effected by a system of conveyor belts, similar to the conveyors used for baggage handling at airports, or by a pneumatic-tube conveyor system, or by a system of robots which transport the item to an intermediate storage area, or by a combination of these options. The transport from the display point to the intermediate storage area can take place above the display area, i.e. above the shelves, or below the display area, or between two rows of shelves.

In a preferred embodiment of the invention, a current shopping list for the customer is prepared in near real-time, for example in a central computer system. By way of terminals, the customer can call this list up at several positions in the market, having first entered his/her individual PIN. The customer can delete positions from the list. The respective items are then removed from the intermediate storage area, usually manually.

Expediently, for all customers, intermediate storage of the items takes place in an intermediate storage area outside the sales area or in the final handover area. In the latter case there is literally no intermediate storage involved. Depending on the expediency, intermediate storage of the items in the intermediate storage area can take place at various locations, or all together in one position for each customer. The locations or location must remain allocated to the customer from the time s/he starts shopping to the time the goods are collected.

The invention is associated with a particular advantage in that the customer is now free to leave the market for a time, for example to shop elsewhere or to have a rest or to meet somebody. After completion of shopping in the market, the customer goes to the goods release area. Here, by entering his/her PIN s/he causes final invoicing and bringing together the items from the intermediate storage area, which items will be handed over to the customer after payment. As an alternative, the customer can also have the goods sent to an address stated by him/her.

After this, all the allocations of the intermediate storage areas and of the PIN to the customer can be deleted. However, the control system can also store PINs that have been allocated so that the customer can be given the option of storing the PIN in his/her own device, for example a mobile phone or a handheld PC, and continue to use this PIN during the next visit. In this case it is expedient if the customer can explicitly enter into a purchase and have it composed via the system, so that when the goods are issued, they can already be arranged for collection.

Issuing the goods can take place by way of automatic devices which, after the PIN has been entered, can print out an invoice and can receive payment in cash or via a card, while at the same time in the background, effecting the composition and request for the goods from the intermediate storage area, before finally handing the goods over to the customer, for example by way of a belt conveyor.

The method according to the invention, and the associated device, largely solve the problems of shopping markets, which problems have been mentioned in the introduction. Customers can freely enter the market and leave it either for good or for the time being, without having to push along bulky shopping trolleys or having to carry their purchases. By handing the purchases over in a central area near the customer's vehicle, repacking can also be saved. Customers can get to the displays, freely decide in favour of particular items, and finally receive exactly the product that they have selected. This is very important in particular when purchasing fresh goods, for example vegetables. By way of a terminal, customers can at any time check their purchases so far and by way of the listing can determine how much money they have spent so far. Customers can make corrections by crossing positions off the list.

The method according to the invention is suitable both for individual businesses and for shopping centres or even for entire communes.

Thus in a shopping centre each business can be connected to the transport system, wherein the customer pays at the time of collecting all the goods purchased, and wherein the goods are handed over to the customer near the customer's vehicle, for example in an underground car park. This allows stress-free shopping without carrying the shopping bags of individual shops. Moreover, misunderstandings are prevented right from the outset which can occur when customers enter a store with goods which have been purchased elsewhere, which this particular store also sells. Furthermore, the storage conditions for temperature-sensitive groceries are considerably better in the intermediate storage area than they would be in the boot of the customer's vehicle.

Application of the invention is not limited to self-contained shops or shopping centres. Even all the business of an entire street can be connected to such a system. Finally, it is also possible to provide for several goods release areas, so that the customer, either when entering the master data or individually, can select where his/her purchases are to be delivered to. Furthermore, storage times can be agreed to, so that for example a cyclist can go shopping during the day while later on a member of the family who is driving a motor vehicle can collect the items purchased. The latter member can even do some shopping and then have all the goods handed over centrally.

It is now possible to design the market area so as to be more attractive and appealing so that the shopping experience is enhanced. Waiting times at cash registers can be reduced in that on the one hand calculation of the total amount to be paid already takes place before going to the cash register, but on the other hand because several departments or even enterprises can invoice together.

As far as the proprietor of the market is concerned, there are no longer any problems with shopping trolleys, and cash register stations and expenditure relating to cash register staff can be saved. Furthermore, shoplifting is reduced because the goods are held in the central store until they are paid for. Where it is not a case of purchasing individual items of a product, but instead a generic purchase takes place, for example cartons of beer, conserves or originally-packaged industrial goods, there is an alternative option, by entering an item code and the PIN in a terminal, of having such an item transported to the intermediate storage area directly from a warehouse. As an alternative, a sample which represents the goods, or a goods purchase card can be selected which subsequently in the intermediate storage area is replaced by the actual goods.

The method and device can be applied to all types of goods which are selected by the customer from among a multitude of items and which can then sensibly be conveyed to an intermediate storage area by means of a transport system. This applies in particular to groceries, health care products, toys, garments and linen, electrical goods, flowers and do-it-yourself products. The method and device according to the invention can also form part of a higher-order sales system, wherein the presentation area and the intermediate storage area as well as the computer system are used jointly.

Essentially, the device according to the invention comprises the following components:
1. a sales area with shelves for presenting goods;
2. a computer system which, depending on the design of the method, comprises a centralised or decentralised computer and terminals as well as respective software for marking the goods selected by the customer, for controlling the transport and storage systems, for locating the goods in the intermediate storage area and for preparing the lists and invoices;
3. a transport system for conveying the goods to the intermediate storage area;
4. an intermediate storage area for storing the goods selected;
5. a transport system for conveying the customer-specific goods to the goods release area; and
6. a goods collection area with devices for paying for the goods and for issuing the goods.

Depending on the goods displayed, the sales area can comprise the respective shelves, freezers, counters, bargain counters and similar for self-service or conventional service. Since customers move past the displayed goods without shopping trolleys, the aisles can be designed to suit marketing requirements, escalators no longer have to be designed for use with shopping trolleys and there is no longer any space needed for parking shopping trolleys.

Near every sales counter there is a terminal which is connected to the central computer system by way of a local network (e.g. LAN or WLAN). At least some functions of the terminals may also be handled by small handheld devices which are handed to customers at the entrance and which are also networked with the central computer, for example by way of a WLAN. The handheld devices are then collected again after payment.

The terminals receive the data for generating or detecting the PIN and the data for detecting the goods by way of a keypad and/or a scanner and/or a barcode reader and/or scales (in the case of bulk goods). The PIN is then printed as a barcode onto the goods or onto a sticker, or it is added, by way of a transmitter, to an electronic label attached to the goods. In another embodiment, near the terminals, transport aids are made available into which or onto which the goods can be placed. After this the goods are conveyed by way of the transport system.

The loading device is matched to the transport system. For example, if the transport system comprises conveyor belts which are arranged above the shelves, then the loading system can comprise lifts such as for example bucket elevators into whose buckets the goods are placed, with the buckets placing the goods onto the belt conveyor. There is a lift on almost every shelf. If such conveyor belts are arranged below the shelves, inclined slides can be arranged between the shelves, onto which slides the goods are placed and by way of which slides they are placed onto the belt conveyor. It is also possible for robot arms, located near each shelf, to take up the goods and place then onto the belt conveyor.

The transport system is used to convey the goods to the intermediate storage area; it can thus comprise belt conveyors, chain conveyors, lifting screws, pneumatic conveyors and similar. Depending on the spatial arrangement of the sales area and the intermediate storage area, several conveyors as well as mixed systems may also be required. The intermediate storage area involves state-of-the-art technology. It is organised along the lines of known high-shelf storage warehouses and is controlled by way of computer systems. The number of its storage areas is one to ten times the number of customers who can be present in the sales area, predominantly twice as many.

At least part of the intermediate storage area is air conditioned so as to cater for temperature-sensitive goods, or so as not to interrupt the refrigeration chain. The goods collection area also is state of the art. It comprises several automatic teller machines which after the PIN has been entered issue an invoice and display the amount to be paid. Cash, bank cards and credit cards are accepted. After payment, a receipt is issued, and the intermediate storage area is informed that these goods are to be delivered.

The intermediate storage area comprises a transport device by means of which the goods designated in such a way are transported to a goods release area in a way known per se, where the customer receives these goods.

The goods release area can also be combined with the pay station, i.e. the cash register. For example, the goods of a customer can be collected in a compartment of a goods release area in the manner of a sorting station, wherein the compartment is filled from the inside with goods, whereupon the customer opens the compartment from the outside to remove the goods. For this purpose the compartment can be locked to the outside by way of a door which is only unlocked after the customer has paid the invoice and has provided identification. This can for example take place by entering the customer's PIN, wherein the goods-release unit for example can comprise numbered compartments and a central automatic payment machine. The customer enters his/her PIN and pays by way of a cheque identification card or a credit card. Subsequently, the door is either unlocked from a remote station, or the customer receives an opening code to be entered on the door. Of course each of the doors can also comprise a reading device, in which case the door is unlocked immediately after payment.

If the PIN is determined on the basis of credit card data, payment in relation to the allocated compartment can also be made without identifying the customer since that information is already contained in the credit card. For example, the customer can carry a portable terminal which contains the list of the goods already purchased, the compartment number of the subsequent goods release area, as well as the value of the purchases.

By way of additional programming of the system, further safety aspects can be taken into account. For example, by way of a credit card, the customer's age can be verified. In this way it is for example possible to prevent the sale of goods that must not be sold to minors, for example DVDs or alcohol. Furthermore, certain characteristics relating to a purchase can be specified. For example if a customer wishes to place a financial limit on a purchase, s/he can save this limit in his or her terminal. Any purchase beyond this limit is then blocked, with goods that have been handed over to the transport system after the limit was reached being stopped from reaching the intermediate store unless either the limit is increased or some other goods are placed back.

1. A method for selling and handing over goods to customers, wherein
within a display area, goods are presented to customers;
an individual identification code in the form of a customer-specific character sequence is allocated to each customer;
goods selected by customers are conveyed to at least one intermediate storage area by way of a transport device;
the goods belonging to a particular customer are identified by verifying the PIN and are conveyed to at least one storage area which is reserved for this customer; and
after payment, and collection from the storage area in the intermediate storage area, the goods purchased by the customer are handed over to the customer in a goods release area of a goods collection area;
wherein at least some of the goods are offered for sale to the customer as concretely singled-out goods, wherein the customer marks these concretely singled-out goods with his or her character sequence (PIN), hands them over to a transport device, with the goods subsequently being conveyed from the sales space to the storage area by way of at least one transport device.

2. The method for selling goods and for handing over the purchased goods, according to claim 1, characterised in that at the time of entering the sales area each customer himself/herself initiates the customer-specific character sequence (PIN) by way of a terminal.

3. The method for selling goods and for handing over the purchased goods, according to claim 2, characterised in that the customer, for initiation of the customer-specific character sequence (PIN), places a machine-readable individual document, in particular an identification document or a credit card, in the terminal, wherein by way of a computer-controlled goods and customer administration system the customer-specific character sequence (PIN) is generated depending on the document read.

4. The method for selling goods and for handing over the purchased goods, according to claim 1, characterised in that the customer carries a passive or an active transponder, wherein at the time at which the customer enters the sales area, the customer-specific character sequence (PIN) is automatically initiated by way of a stationary active or passive transponder.

5. The method for selling goods and for handing over the purchased goods, according to claim 1, characterised in that generating the customer-specific character sequence (PIN) takes place by means of a biometric characteristic, in particular by means of a finger print, of a full image or partial image of a person or of the iris of an eye of a person, wherein the customer at the time of entering the sales area enters the biometric characteristic by means of an input device (scanner) on the terminal of a central computer, and the system generates the customer-specific sequence (PIN).

6. The method for selling goods and for handing over the purchased goods, according to claim 1, characterised in that generating the customer-specific character sequence (PIN) takes place by means of a personal object to be produced by the customer, in particular of an item of jewellery or a car key, wherein the object is acquired at the terminal of a central computer by means of image recognition of an input device (scanner), and the customer-specific character sequence (PIN) is allocated to the object.

7. The method for selling goods and for handing over the purchased goods, according to claim 5, characterised in that the generated customer-specific character sequence (PIN) is stored in a database for repeated use by the customer.

8. The method for selling goods and for handing over the purchased goods, according to claim 1, characterised in that following the allocation of a customer-specific character sequence (PIN), by way of a printer, labels comprising the customer-specific character sequence (PIN) or some associated character sequence are printed, wherein the customer marks goods by sticking a label onto the goods themselves in the case of concretely singled-out goods, or onto an image of the goods in the case of non-specific goods.

9. The method for selling goods and for handing over the purchased goods, according to claim 1, characterised in that the goods comprise a writable data carrier (chip), wherein in the sales area at least one data writer is arranged, by way of which the customer can write the customer-specific character sequence (PIN) on the data carrier.

10. The method for selling goods and for handing over the purchased goods, according to claim 9, characterised in that a chip located on the goods, in particular an RFID, is used as a writable data carrier (chip), wherein said chip comprises customer-non-specific data concerning the goods.

11. The method for selling goods and for handing over the purchased goods, according to claim 9, characterised in that the customer enters his/her customer-specific character sequence (PIN) to the data writer by way of a keypad.

12. The method for selling goods and for handing over the purchased goods, according to claim 9, characterised in that the customer carries a transmittable storage device, in particular a PDA computer or a mobile phone, wherein the customer-specific character sequence (PIN) is stored therein, and the transmittable storage device conveys the customer-specific character sequence (PIN) to the data writer by way of wireless data transmission, in particular by way of a Bluetooth connection, either via a network or directly.

13. A logistics system for handling the sale of goods and for handing over the purchased goods to customers, comprising
at least one display area for presenting the goods;
at least one computer system comprising at least one computer and/or terminals and software for carrying out marking of the goods which have been concretely singled out by the customer, for the purpose of controlling the transport and storage systems and/or for finding the goods in the intermediate storage and for preparing lists and invoices;
an intermediate storage area for storing the goods to be purchased by customers;
a goods collection area with devices for paying for the goods and for issuing to the customer the goods that have been paid for; and
a transport system which extends from the display area by way of the intermediate storage area and from the intermediate storage area to the goods release area, for conveying the customer-specific goods to the intermediate storage area and for conveying the goods to the goods release area.

14. The logistics system for handling the sale of goods and for handing over the purchased goods, according to claim 13, characterised in that at least some of the terminals are wireless terminals which are able to correspond with a controlling computer system.

15. The logistics system for handling the sale of goods and for handing over the purchased goods, according to claim 13, characterised in that the transport system is arranged between the display area and the intermediate storage area, between two shelves, above shelves and/or below the shelves.

16. The logistics system for handling the sale of goods and for handing over the purchased goods, according to claim 13, characterised in that the transport device comprises belt conveyors, chain conveyors, robots driving at regular intervals through the display area, pneumatic conveyors, lifts and/or loading robots.

17. The logistics system for handling the sale of goods and for handing over the purchased goods, according to claim 13, characterised in that said logistics system comprises terminals for input by customers, with said terminals comprising keypads, scanners, cameras, displays, touchscreens, sensors for electronically marking labels, and/or scales.

18. The logistics system for handling the sale of goods and for handing over the purchased goods, according claim 13, characterised in that along the transport system said logistics system comprises input devices for acquiring the goods selected by the customer, wherein said logistics system is able to add up the goods allocated to a customer and to issue the calculated value at a pay station.

19. The logistics system for handling the sale of goods and for handing over the purchased goods, according to claim 18, characterised in that the pay station is an automatic teller machine for payment by means of cash, debit cards or credit cards.

20. The logistics system for handling the sale of goods and for handing over the purchased goods, according to claim 13, characterised in that the transport system comprises closed channels with transport means arranged therein and with input stations for entering goods, wherein, for the purpose of safe-guarding the selected goods, the transport means are not accessible within the sales area.
